(19) United States
(12) Patent Application Publication
(10) Pub. No.: US 2005/0091106 A1
(43) Pub. Date: Apr. 28, 2005

(54) Selecting ads for a web page based on keywords located on the web page

(76) Inventors: William McLain Reller, Seattle, WA (US); Sean Patrick Nolan, Bellevue, WA (US)

Correspondence Address: GRAYBEAL, JACKSON, HALEY LLP, 155 - 108TH AVENUE NE, SUITE 350, BELLEVUE, WA, 98004-5901, US

(21) Appl. No.: 10/694,643

(22) Filed: Oct. 27, 2003

(51) Int. Cl. G06F 17/60

(52) U.S. Cl. 705/14

(57) ABSTRACT

A system for use on computer servers on a network serving client computers for selecting an advertisement to be presented among a plurality of possible advertisement candidates based on key words. When a client computer requests a document from a server on the network, the system considers words contained within the document and compares them to a set of key words for each possible advertisement of a plurality of possible advertisements. The system selects an advertisement to be presented with the information where a key word associated with the advertisement matches one or more words in the document. If more than one advertisement qualifies, the system considers a price value of each advertisement and a relevance score for each word, which is a function of proximity to the start of the document, to determine which advertisement will be presented.

### BACKGROUND

For most web site advertising, advertisements are provided by an advertising placement company into ad slots specified by the web site owner. The web site owner may require that no ads be provided for a business that competes with the web site owner, but there is little other guidance for the ads that are placed. The advertising placement company can read each page on a site and try to select ads to appear with that page that are related to the subject matter of the page, but this is usually considered too labor intensive.

### SUMMARY OF THE INVENTION

A first aspect of the invention uses an automated computer system to evaluate the content on a webpage and then deliver for display with the page targeted ads that relate to content on the webpage. The content is evaluated by identifying keywords used on the page, giving each a weight, and using the weighted keywords as an indicator of content to select targeted ads to be shown with that page.

A second, related aspect is to track keywords that were entered by a user into a search engine to find the page and then deliver still more targeted ads for that particular user based on the keywords entered by the user to find the page.

One embodiment of the system applies both a relevance algorithm and a revenue algorithm to the content on a web page and then delivers the most productive advertisements from a single source or a variety of advertising sources. By evaluating the content on a web page and selecting the most productive advertisements (relative to that content) to deliver to the end-user, this method helps media companies generate revenue and merchants find customers.

One embodiment of the invention implements the following steps:
1. First, we evaluate any web page to understand its context. We consider the phrases that we seek in this evaluation to be key words. An article about the Seattle Seahawks might find “Seattle Seahawks” to be most relevant key word and “football” to be second most relevant.
2. If more than one keyword is found to be relevant, or more than one advertisement is selected by a key work, we rank the keywords and advertisements based on which advertisements are going to generate the most revenue. Factors that influence this are its overall relevance (relevance score) to the page, revenue per impression, revenue per click and actual or expected click rates. We can select from multiple ad partners to select the most valuable ad. So if Google is going to pay $0.40 per click for ads associated with “Palm Pilot”, and Overture is going to pay $0.60 per click for ads associated with “Palm Pilot” that we would show the Overture ads because they pay more.
3. Then we serve the ad.

### BRIEF DESCRIPTION OF THE FIGURES

The features of the present invention which are believed to be novel are set forth with particularity in the appended claims. Aspects of the invention may best be understood by making reference to the following description taken in conjunction with the accompanying figures wherein:

FIG. 1 shows a dictionary tree for a set of word phrases.

FIG. 2 shows the cost per click values of different words from multiple ad sources.

FIG. 3 shows a decision matrix for selecting among ads to be placed.

FIG. 4 shows how ad types may be selected based on partner requirements, keyword relevance and keyword value.

### DETAILED DESCRIPTION

The following detailed description and the figures illustrate specific exemplary embodiments by which the invention may be practiced. Other embodiments may be utilized and other changes may be made without departing from the spirit or scope of the present invention. The following detailed description is therefore not to be taken in a limiting sense, and the scope of the present invention is defined by the stated claims.

The invention encompasses computer methods, computer programs on program carriers (such as disks or signals on computer networks) that, when run on a computer, implement the method, and computer systems with such a program installed for implementing the method. The various embodiments of the invention may be implemented as a sequence of computer implemented steps or program modules organized in any of many possible configurations. The implementation is a matter of choice dependent on the performance requirements of the computing system implementing the invention.

For explanation, an embodiment of the invented method may be divided into three steps with an optional fourth step. The practical application of these steps can be seamlessly integrated or separated into independent components.

1. Evaluate the content on a page for keyword relevance. (Keyword lists may be generated internally and/or provided by advertisers and/or advertising partners.) This evaluation applies an algorithm that considers both the number of occurrences and the location of the occurrences of any given keyword (or words or phrases associated with a given keyword) and, using this information, gives each keyword on the page a “Relevance Score.” This algorithm is explained in detail below. From this analysis, a media company could choose to show a list of relevant keywords as “related searches” that will link to search results. Alternatively, the information could be used to pull advertisements as detailed below.

2. Query a group of advertising partners (or a single advertising source) to learn the revenue generation potential of each keyword (“Cost Per Click” or “Cost Per Impression”) from each partner. Apply this data to the Relevance Score to determine a “Productivity Score”. Overtime, click-thru rates of certain advertisements and keywords may influence the potential revenue production of keywords which, in turn, may influence the Productivity Scores.

Some of the “advertising sources” may be developed by enabling media sites with ability to allow their own advertisers/viewers to bid for ad placement using ad bidding technology. Advertisers and/or media partners will determine if ads loaded thru this system will be limited to the media site where the ad was originated or distributed across the entire Company network.

3. Productivity Score (and Relevance Score and Cost Per Click or Cost Per Impression) will be used to determine the advertiser and the type of advertisement to display (banner, button, pop-up, etc.) with the page.

For example, consider a web site run by a news organization such as the Seattle Times. They run an article about The Seahawks and, if they have advertising on the webpage, it is non-targeted. The invented system would place ads for Seahawk Tickets, Seahawk Memorabilia and Football related merchandise. The system does this by reading the content on a page and comparing that content to a long list of keywords. The system applies an algorithm that considers the number of occurrences and location of the different keywords on the page. The system also can consider the number of words in a keyword (keyword phrase), and the potential value derived from showing ads related to a particular keyword. In this way, the system can serve advertisements that are much more likely to be of interest to the reader of the page—therefore delivering superior value to the advertiser and the media sites.

4. As an optional fourth step, the system can be designed to also consider the apparent interests of a particular user if the user came to the page from a search based on search words entered by the user. For example, the Seattle Times web site includes a search feature. Each article can be found as a result of many different searches with different words, all of which will lead to the same article. However, a user that comes to a particular article from a search for “sports events in Seattle” might be shown different ads based on the words used in that search phrase than a user that comes to the article from a search on “NFL”. The words used by the user in the search are used to further adjust the selection of ads to show to that user by consulting the same long keyword list.

Where the search engine is a part of the same site as the web pages that are found from the search, implementation of this fourth step is straight forward. To implement this fourth step with search engines that are not part of the site, a parameter consisting of the search words entered by the user to find the hyperlink must be passed from the search engine site to the page that is specified by the hyperlink. This is preferably done by the search engine site adding the search words as a parameter at the end of the hyperlink. Software on the host computer for each web page is modified to interpret this parameter. Alternatively, the parameter may be passed via a cookie placed on the user's computer. By using cookies, words used in prior searches that led to the same page can also be passed as additional parameters. Additionally, words used in prior searches can influence the advertisement selection of future pages regardless of the content on the page. So a user who searches for “cell phones” could be determined to be interested in cell phones and shown ads related to cell phones even when they are reading a page related to President Bush.

### Determining Relevance score for each Phrase on a Page of a Web Site

The system receives as input all the words of a web site page and organizes them into phrases as is well known in search technology. Documents are composed of, or normalized into, text fetched using a network or other means and parsed into a stream of words. Then, given this set of phrases from a source document (web page), the system quickly returns a list of phrases that appear in the document, ordered descending by a measure of relevance. For example, a measure of relevance for each word might be based on location in the page according to the following ruleset:

| Location of keyword in body | Weights |
|---|---|
| 01-30 words | 10 |
| 31-100 words | 7 |
| 101-500 words | 2 |
| 501-1000 words | 2 |

Phrases consist of one or more keywords. Using the weights stated above, the system computes a maximum bid (“overall relevance value”) for each phrase. The phrases of the page are arranged on system startup into a tree structure designed for efficient searches.

DATA STRUCTURES FOR DETERMINING
RELEVANCE OF PHRASES
Phrase

| | |
|---|---|
| Phrase ID | Integer |
| Keyword Count | Integer |
| Keywords | String, whitespace separates keywords |

PhraseMatchNode (associates state data with a phrase)

| | |
|---|---|
| Phrase | Pointer to phrase |
| Match Info | Bitmask, purpose depends on context |
| Relevance | Integer |

KeyTreeNode (represents component
keywords that make up phrases)

| | |
|---|---|
| Keyword | Implicit string based on position within the |
| | dictionary tree, not stored within node |
| Phrase/Position List | Array of PhraseMatchNode pointers for |
| | phrases that contain this keyword, sorted |
| | by Phrase ID. Match Info in the PMN is a |
| | bitmask representing the position(s) of this |
| | keyword in the phrase. |
| Child KTN List | Array of KeyTreeNode pointers for |
| | children of this node. 256 elements, |
| | addressed directly by character value. |
| | Mechanisms for reducing the sparseness of |
| | this array are in place. |

Dictionary Tree

During startup, each phrase is broken down into its component keywords. Regardless of how many times keywords are represented in phrases, each is represented only once in the system by a unique KeyTreeNode (“KTN”). The keyword that a KTN represents is not stored in the KTN itself; it is implied by the location of the KTN in the dictionary tree.

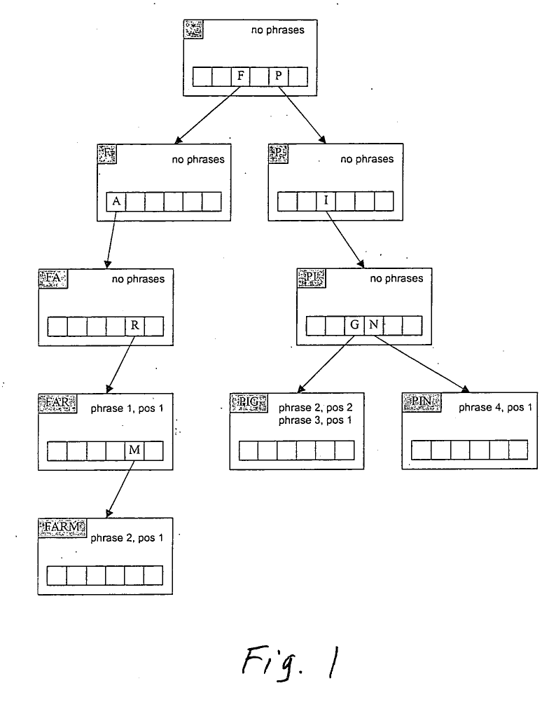

KTNs are loaded into a dictionary tree in which each node represents a letter in a particular ordinal position in the keyword. Also associated with the KTN is an array of Phrases that contain the implied keyword. It is easiest to make sense of this using a diagram as shown in FIG. 1. Assume a system with the following four phrases:
Phrase ID 1: FAR
Phrase ID 2: FARM PIG
Phrase ID 3: PIG
Phrase ID 4: PIN

Note that all words are normalized for punctuation and converted to lower-case.

The dictionary tree for this setup will have the structure shown in FIG. 1.

Note that for each phrase/keyword pair (the Phrase Match Node array, “PMN”) position information is stored as a bitmask: position 1=0x00000001, position 3=0x00000004, and so on. If a keyword appears in more than one position in a phrase, multiple bits will be set. For example, if a phrase is “big big fish”, in the PMN for “big” the bitmask will be 0x00000003 (first and second bits set).

Live editing of the tree is supported. A combination of CPhrase refcounts and KTN-level locking allows for a thread-safe interface to the tree.

Matching Process

Two interim collections of PhraseMatchNodes (“PMNs”) facilitate the matching process. The “hit array” contains phrases that have matched the document. A phrase will only be represented in the hit array once, but relevance from multiple matches will accumulate in that PMN. The hit array is sorted by phrase id for easy lookup.

The “candidate list” contains phrases that match “so far”. That is, some subset of their keywords have matched but not all. As each word from the document is examined, PMNs are added to or removed from the candidate list as appropriate.

The following pseudocode describes the matching process:

```
HitArray [symbol] empty
CandidateList [symbol] empty
For Each keyword in document
  ktnKeyword [symbol] Lookup keyword in the dictionary tree
  If ktnKeyword != Null
    // process existing candidates
    For Each pmnCandidate in CandidateList
      pmnKeyword [symbol] Lookup pmnCandidate.PhraseID
      In ktnKeyword PMN List
      If pmnKeyword != Null
          // this keyword is in the candidate phrase
          Shift pmnCandidate.MatchInfo left by 1
          If (pmnKeyword.MatchInfo & pmnCandidate.MatchInfo)
            // the keyword is in the correct position
            If we've matched the entire phrase
              Move pmnCandidate.phrase to HitArray
            Else
              Leave pmnCandidate in CandidateList
          Else
            Remove pmnCandidate from CandidateList
      Else
        Remove pmnCandidate from CandidateList
    // add new phrases that begin with this keyword to the candidate list
    For Each pmnKeyword In ktnKeyword PMN List
      If pmnKeyword.MatchInfo has bit 1 set
        If pmnKeyword.Phrase.KeywordCount = 1
          Add pmnKeyword.Phrase directly to HitArray
        Else
          Add new pmnCandidate for this phrase to CandidateList
  Sort the hit array by relevance and return
```

Expanding the Model for And AND or Matching

The above described bitmask-matching model also lends itself well to AND and OR keyword matches. In both cases, a “target” bitmask is maintained with the phrase, in which the rightmost KeywordCount bits are set. For AND matches, each position PMN match info is logically ORed with found positions; when the PMN match info is equal to the target bitmask all terms have matched. Note that in this case candidates remain in the candidate list even when subsequent keywords did not match, unlike exact matching. OR matches are even simpler in that every phrase that matches a keyword is automatically added to the hit array.

Base Keyword Relevance

As each keyword is parsed out of the document, it is assigned a base “relevance” score. This score is derived from a named ruleset, of which there is always at least one in a running instance of the system. Rulesets can be added or removed from the system during runtime using a web services interface.

By default, the default ruleset named auto is used to generate relevance scores. If there is a tail-match between any ruleset name and the host portion of the document URL, that is used instead. For example, if a document is fetched from host “www.foo.com” and a ruleset named “foo.com” exists, it will be used. Finally, if the engine encounters a tag of the format <tstags-NAME>, the system will search for a ruleset named NAME and use it if found. This manual directive will override any prior ruleset selection. Rulesets may also be customized based on the host name of the system publishing the content, providing the best interpretation of each unique document format.

Rulesets are specified as XML fragments such as the one below:

```
<ruleset name=“auto”>
    <overrides>
        <override name=“title” weight=“10”/>
        <override name=“h1” weight=“10”/>
        <override name=“h2” weight=“8”/>
        <override name=“script” weight=“0”/>
        <override name=“style” weight=“0”/>
    </overrides>
    <body tag=“body”>
        <range maxwords=“100” weight=“7”/>
        <range maxwords=“1000” weight=“3”/>
        <range maxwords=“1500” weight=“1”/>
    </body>
</ruleset>
```

By default, the system will examine as keywords only words that appear in the logical body of the document. What constitutes the logical body is defined by the body section of the ruleset. The tag attribute on the body tag indicates the tag that surrounds body content. Normally this is the standard HTML “body” tag. However, this is an imperfect model because the “body” of an HTML document contains navigation and other interface components, menu text, stock headers and footers, and so on that should not be considered as part of the unique content of the document. The system overcomes this by allowing the content publisher to specify what tag surrounds the logical body. This can be a new tag such as <ts-body> created specifically for the system, or it may be another tag already in place.

Keywords within the logical body are broken down by the system into ranges based on ordinal position. The range tags specify what relevance (aka weight) should be given to keywords within each range. Generally, words closer to the beginning of the document are given more weight as they are typically the topic sentence and paragraph of an article. After the largest range has been processed (1500 words in the sample ruleset above), parsing is terminated.

Overrides make up the remainder of a ruleset. Each override specifies a tag within which keywords are given an absolute weight, regardless of their position in the document. In the sample ruleset, for example, anywhere in the document that a “title” tag is found, the words within it will be given a weight of 10.

NOTE: The system also allows the specification of attribute name/value pairs in ruleset definitions. This is necessary to do a good job of ruleset definition for many existing sites.

Aggregated Relevance

The relevance scores for each keyword are summed during the lifetime of the match process and eventually collected in the match node for each hit. So, assuming (1) we are using the sample ruleset above, (2) there is a query for “big dog” in the system, and (3) that phrase appears twice in the document body, once in the title and once between the 110^{th} and 1,000^{th} words in the body, relevance would be computed as follows:

| | |
|---|---|
| “big” found in title | 10 |
| “dog” found in title | 10 |
| “big” found in 100-1000 range | 3 |
| “dog” found in 100-1000 range | 3 |
| Aggregated Relevance | 26 |

This algorithm selects for phrase length, frequency in the document, and positions in the document. After performing a descending sort by aggregated relevance, we have identified the “best” phrase matches for the document.

At this point financial and productivity rules can be applied to select the best advertisements based on the phrase matches.

Determining Productivity Score for each Phrase on a Page of a Web Site

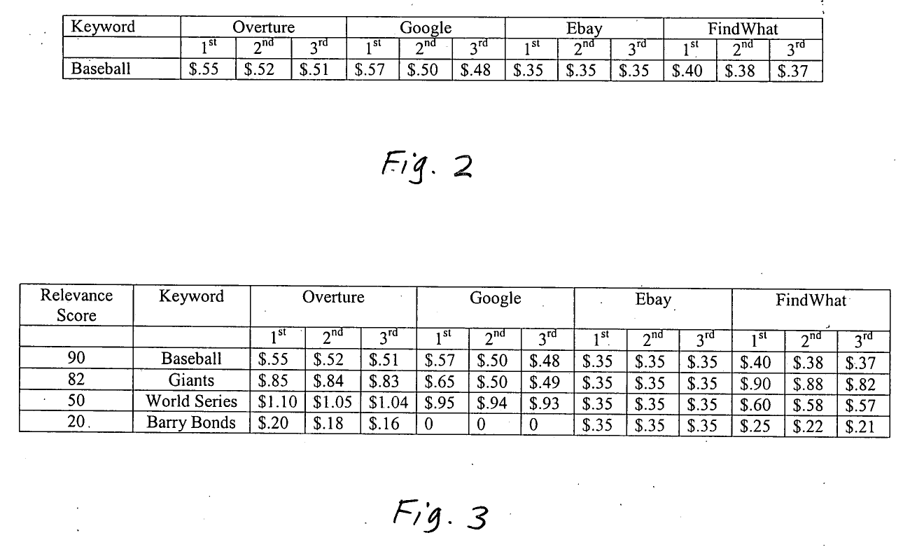

FIG. 2 shows the Cost Per Click (“CPC”) values of different words from multiple ad sources. In this example, each ad source is shown to have three advertisements that match each word. In practice, each ad source could have infinite advertisers willing to buy ads triggered by specific keywords, and those ads could be sold on a CPC basis or on a Cost Per Impression (“CPM”) basis. Additionally, while four ad sources are being considered in this sample table, there is no limit to the potential list of ad sources that the system can utilize-yellow page publishers, classified ad publishers, LookSmart, Ah-Ha, Ad Networks, large advertisers (i.e. Amazon) and others are all suitable advertising content providers.

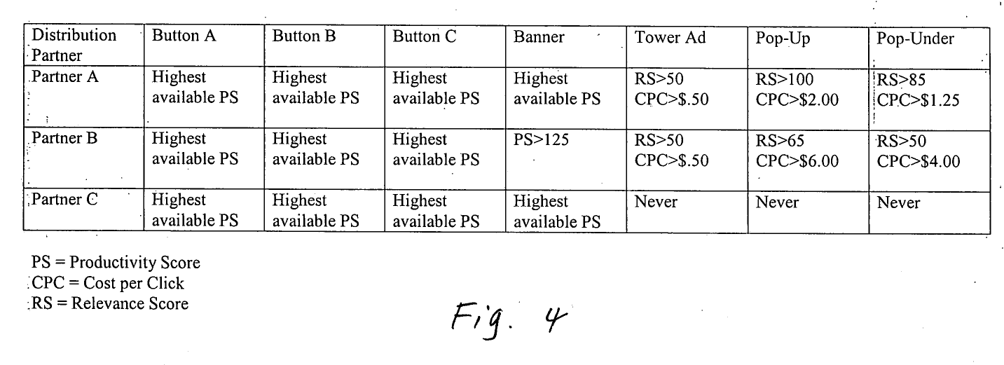

With respect to FIG. 3, assume that the only keyword match on a page is “Baseball” and that a web site owner (“distribution partner”) wants three ads shown on their page. Under this situation, as indicated by the price numbers in the table in FIG. 3, Google's 1^{st} ad would appear in the first ad position; Overture's 1^{st} ad would appear in the second ad position and Overture's 2^{nd} ad would appear in the 3^{rd} ad position. In this way, the most productive ads are shown to the end user.

The issue gets more complicated when considering multiple keyword matches for a specific content page. Under such a scenario, the Relevance Score for each keyword and the CPC or CPM of each keyword are considered. The algorithm is adjusted over time and may vary from one distribution partner to another dependent on user behavior and partner desires. The example in FIG. 3 shows how this works. The most relevant word on the page is “baseball” with a relevance score of (90) and a maximum CPC of $0.57. “Giants”, the second most relevant word on the page with a relevance score of (82), has a maximum CPC value of $0.90. The system recognizes that Giants' Relevance Score is 9% less that of Baseball but the maximum value of a click from the word Giants is 58% greater that the maximum value of a click from the word Baseball. Given this, the system is programmed to show the $0.90 CPC advertisement for Giants ahead of the $0.57 CPC advertisement for Baseball. Dependent on weighting given to the relevance score, the system may be programmed to select the $1.10 World Series ad ahead of that of the others.

After selecting the most productive advertisements to deliver, the system determines, based on rules set by the distribution partners, the ad type to serve. These ad types vary based on partner requirements, keyword relevance and keyword value. FIG. 4 shows the flexibility of the system and the value of the model. Partner C determines that the system will serve a banner and three buttons. The section of the ads will be based on the highest available productivity score. Partner A differs from Partner C in that Partner A will include more intrusive ads when both the relevance scores and ad values are high. For example, when the Relevance Score exceeds 100 and the CPC exceeds $2.00, Partner A's users will receive a pop-up. Using this technology, distribution partners can limit the use of invasive advertising to when there is a high degree of relevance for a high value keyword, minimizing user backlash and maximizing revenue.

Using Categories

In addition to identifying the most relevant keyword(s) on a webpage, the system can be configured to identify a relevant category of the webpage and can make advertising decisions based on that category. For example, in addition to identifying a page as being about “wireless phones”, we also identify it as being about “electronics.” In this way, an “electronics” retailer can choose to have their ads only served on pages about “electronics” and a “sports” retailer could limit the display of their ads to pages about “sports”. Category relationships are assembled in a table by starting with a list of categories such as used in telephone directory yellow pages, and then listing for each category the common words or phrases that belong in that category. Then, if the user has entered the word or phrase, the associated category will be invoked. Alternatively, if a word or phrase that appears in a highly relevant location in a document being served is listed in the table, the associated concept can be used to select ads to be placed.

Although the present invention has been described in considerable detail with reference to certain preferred embodiments, other embodiments are possible. Therefore, the spirit or scope of the appended claims should not be limited to the description of the embodiments contained herein. It is intended that the invention resides in the following claims.

1. A method for selecting advertisements for presentation to client computers on a computer network, comprising:
(a) having on a server computer a plurality of possible advertisements that may be presented to a client computer and having at least one key word associated with each advertisement;
(b) receiving from a client computer a request for delivery from a server of a document containing words;
(c) selecting from the plurality of advertisements a first selected advertisement and a second selected advertisement for which an associated key word matches a word in the requested document;
(d) comparing a value associated with the first selected advertisement and a value associated with the second selected advertisement and further selecting the advertisement with the higher value; and
(d) delivering to the client computer the further selected advertisement along with the requested document.

2. The method of claim 1 further comprising giving greater weight to matching words that are close to a beginning of the document than matching words that are farther from the beginning of the document.

3. The method of claim 1 further comprising: tracking keywords entered by a user into a search engine to find the document and then delivering still more targeted ads for that particular user based on the keywords entered by the user to find the document.

4. The method of claim 1 further comprising: using words entered by a user in prior searches to determine the advertisement to be presented to the user when subsequently viewing other pages regardless of the content on the page.
